(19) United States
(12) Patent Application Publication
(10) Pub. No.: US 2002/0169660 A1
(43) Pub. Date: Nov. 14, 2002

(54) Comprehensive, fully integrated online promotion program for goods and/or service providers doing business online and/or offline

(76) Inventors: Jason Brandon Taylor, Evanston, IL (US); Christopher M. Jackson, Chicago, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/852,214

(22) Filed: May 9, 2001

(51) Int. Cl. G06F 17/60

(52) U.S. Cl. 705/14; 705/26

(57) ABSTRACT

An online, fully integrated promotion program is disclosed having a promotion program tool in which a program participant acquires a quantity of promotion program points, reviews an upcoming real world event, reviews a select set of possible outcomes for the event, and selects one of the possible outcomes as a prediction entry. The participant also associates the quantity of points with the selected prediction entry. The selected prediction entry can be classified as a winning prediction entry if the outcome of the real world event corresponds thereto. If the prediction entry is a winning prediction entry, the promotion program administrator distributes a reward to the program participant for making a winning prediction entry during participation in said promotion program. Additional promotion program tools can be included within the promotion program.

### BACKGROUND OF THE INVENTION

The present invention relates generally to a promotion program. More particularly, the present invention relates to an online promotion program that is comprehensive, fully integrated and interactive, and that includes promotion program tools allowing for utilization by clients doing business online, offline, or both. Still more particularly, the present invention relates to a business-to-business online promotion program that can be provided by a promotion program provider to offer its clients, as a promotion program tool, a consistently updated gaming architecture based on prediction of upcoming real world events to build brand awareness and loyalty and to offer the clients clever, cost-efficient methods of attracting, engaging and retaining promotion program users/participants.

Throughout this description, reference will frequently be made to promotion program providers, promotion program clients and promotion program participants. It will be appreciated that, as used herein, promotion program providers provide promotion programs to their clients.

It will further be appreciated that, as used herein, the promotion program clients are persons and/or business organizations (e.g., persons, corporations, partnerships, limited liability companies) that typically offer products and/or services to the public or a select group thereof under one or more brand names. For instance, promotion program clients could sell books, sound recordings, or even candy bars, and can do so online and/or offline. Promotion program clients can also be internet portals or news websites that generate revenue through subscription offerings and/or click through royalties, such as by using HTML hyperlinks, banner advertising and the like. For present purposes, the promotion program clients can be virtually any product and/or service provider, and can do business online and/or offline. In that regard, and as will become apparent through reading this description, the comprehensive, fully integrated online promotion program described herein, and any of its promotion tools forming components of the program, can be advantageously utilized by clients doing business online, offline, or both.

Still further, it will be appreciated that program participants are actual or potential consumers of the goods and/or services offered by the promotion program clients. The program participants partake in the program in hopes of obtaining any of the offered prizes, incentives, coupons and other rewards. As used herein, coupons shall include discounted offerings and the like.

In this description, promotion program providers have been described as an entity separate from the promotion program clients. While this is the preferred case for reasons that will be apparent through reading this description, it will be understood that the product and/or service providers could develop and offer their promotion programs directly to the consumers. Under such circumstances, the promotion program provider would be the product and/or service provider and no provider-client relationship would exist. As used herein, when a provider-client relationship exists, a promotion program administrator shall be considered to be the promotion program provider, the promotion program client, or both. As also used herein, when no provider-client relationship exists, a promotion program administrator shall be considered to be a product or service provider that implements a promotion program. Taking this into consideration, unless otherwise explicitly limited thereto, the claims forming the conclusion of this description shall not require that the promotion program provider and promotion program client be separate.

As will be appreciated, it is the ultimate goal of every product and service provider to generate revenue through the sale of goods and services to consumers. One well known way to generate sales is to build a base of loyal consumers. Loyal consumers are typically repeat customers. Repeat sales increase profits.

A proven method of obtaining and retaining loyal consumers is through the use of promotion programs. Well-known examples of promotion programs include the frequent flyer programs generally offered by airline companies to passengers, who consume the airline travel service offered by the companies. Airline passengers participating in frequent flyer promotion programs are participants of the program and accumulate miles through a number of different ways, including traveling on a flight offered by the airline. Once a preselected number of miles is accumulated, the program participants can apply the accumulated miles to certain ones of the prizes, incentives, gift certificates and other rewards offered through the program. Examples of such rewards typically include free travel to select destinations and free upgrade to more desirable seating on flights (e.g., first class seating).

Promotion programs are not used only by the airline industry. Promotion programs have been used by other product and service providers for a long time.

With the advent of the internet as a medium for commercial activity where goods and services are offered to consumers for purchase (what has become known in the art as ecommerce), promotion programs are now available both online and offline. To wit, it was estimated that over 1.8 billion dollars would be spent on online promotions in the year 2000, with nearly thirty-five million registered domain names competing for an audience of two hundred forty million internet users worldwide. It is expected that the number of web pages and internet users will rise dramatically in the near future, and the amount spent on internet-based promotions is anticipated to follow the trend, rising to over fourteen billion dollars by the year 2005. Another noticeable trend is that the percentage spent on online promotions as compared to online advertising is expected to jump from an estimated thirty-three percent in year 2000 to fifty-four percent in year 2005.

As stated above, online companies have utilized online promotion programs. These online promotion programs utilized by online companies initially were standard database (customer list) building sweepstakes in which a user places an entry in a sweepstakes by identifying certain demographic information related to her. These promotion programs later evolved into more retention-based programs to build brand loyalty, which included games and loyalty programs, resembling, to a certain extent, the frequent flyer promotion programs described above.

Deficiencies of these prior online promotion programs utilized by online companies indicate that the gap between the two concepts of attracting program participants and retaining them has not been easily filled. Most program participants require a dynamic promotion model that can be updated periodically to retain their interest. Participants become quickly bored with static models. Furthermore, the basic architecture for the promotion model must be exciting and engaging in order to attract promotion program participants. The cost (in terms of expense and time) required to develop an exciting online promotion program and update it periodically is generally overwhelming to companies that are entirely focused on the sale of goods and/or services. These deficiencies are solved by the comprehensive, fully integrated online promotion program described herein.

Offline companies have only recently begun to launch online promotion programs. In that regard, only the leading offline companies have established such programs. Typically, in these promotion programs, demographic information of consumers is entered by a program participant to register for participation in the program. As such, that information is collected and utilized for marketing efforts. Incentives and coupons are generally offered as the prizes and rewards for these programs based on their particularities.

As is the case with online companies, for offline companies utilizing online promotion programs, the deficiencies indicate that the gap between the two concepts of attracting program participants and retaining them has not been easily filled. Again, the cost (in terms of expense and time) required to develop an exciting online promotion program and update it periodically is generally overwhelming to companies that are entirely focused on the sale of goods and/or services. These circumstances are even more likely in the case of offline companies as opposed to online companies inasmuch as offline companies are typically significantly less familiar with marketing their wares to internet users and less familiar with the technologies presented by the internet. As stated above, these deficiencies are solved by the comprehensive, fully integrated online promotion program described herein.

Referring to some of the prior online promotion programs, one online promotional company has established a loyalty and retention program, primarily directed to distribution of coupons. This company has an open loyalty platform to provide participants with promotion and sweepstakes opportunities. The content is delivered to the participants over the internet by way of banners and pop-up windows.

Another online promotional company offers and manages promotions, and collects consumer demographic profiles. The company provides co-branded fully serviced sweepstakes and instant wins for participants.

Yet another online promotional company focuses primarily on consumer loyalty programs. This company customizes loyalty networks for its clients. The rewards given to participants in its promotions are in the form of points or offline rewards such as those obtainable in the known frequent flyer promotion programs.

Still another online promotional company offers direct e-mail services along with standard promotion programs, including sweepstakes.

Another online promotional company offers a selection of loyalty marketing and promotional tools, including online sweepstakes, online scratch-off instant win game pieces, and online coupons. Gaming tools are offered, primarily in the form of instant win games and scratch-off games, and there further exists the ability to link to casino game websites, along with the ability to acquire demographic and contact information of the program participants.

While several prior online promotion programs have proven to be useful for certain, limited applications, they have significant shortcomings. One basic shortcoming common to many of the prior online promotion programs is that they do not have the ability to require site registration to participate in the offered programs. As will be appreciated by those skilled in the art, the encouragement of site registration permits marketers to obtain demographic and contact information for program participants, who are the consumers of goods and services offered by the promotion program client. This demographic and contact information is invaluable for marketing and advertising of products and services offered by the client.

Still another significant shortcoming of the existing online promotion programs is that they do not ordinarily reward site visitors and program participants for actions defined by the program client. An example of a client-defined action is the making of a purchase. Another such example is completion of a survey. Still another example is the establishment of a financial credit account. As will be appreciated, the client is in the best position to determine its particular needs. Accordingly, failure to allow the client to define the actions in which program participants (consumers) will be rewarded is a significant shortcoming of the existing online promotion programs.

Yet another shortcoming of the existing online promotion programs is that the programs generally are not dynamic in that they cannot be easily and continually updated, as desired. As a result, program participants become quickly bored, and therefore less likely to continue participation in the promotion program. This, in turn, translates into lost business opportunities for the promotion program client.

Another shortcoming of the existing online promotion programs is that they do not include a consistently updated gaming architecture based on upcoming real world events to offer clever, cost-efficient methods to retain and maintain program participants, who in turn hopefully become loyal consumers of the goods and/or services sold by the promotion program client.

While there are surveys and polls online asking internet users to predict the outcome for upcoming real world events, these are primarily provided for entertainment purposes and do not result in the reward of prizes and incentives to correct respondents. More particularly, these polls have not been tied into a promotion program model in which correct prediction of the outcome can result in the reward of prizes, incentives and other rewards specified by a promotion program client. The promotion program described herein includes a promotion program tool that makes this connection to yield a unique, exciting, dynamic promotion program.

As identified above, some prior online promotion programs have included sweepstakes games and/or casino games as a basis for determining whether to reward promotional offerings to program participants. In one respect, a sweepstakes game or casino game could be classified as a real world event and, accordingly, its outcome could be classified as the outcome of a real world event. When a participant in those programs correctly predicts the outcome of the game, such as correctly identifying that the next spin of a roulette wheel will result in the marble coming to rest in a wheel slot bearing the color red, it could be said that the participant has correctly predicted the outcome of a real world event (i.e., the spin of the roulette wheel).

The events used for prediction-like games in prior online promotion programs have been directed to online activities, where the game occurs online. Furthermore, the outcome of the sweepstakes and casino games have been within the control of the promotion program provider, or alternatively, have had a select number of outcomes, each having a scientifically measurable probability of occurring. For example, on a conventional U.S. roulette wheel, it is known that there are thirty-eight slots, each having one number assigned to it. Each slot has an equal chance of being the winning slot for any given roulette wheel spin. Simple math dictates that there is a one in thirty-eight chance for any given slot to be the winning slot for any given roulette wheel spin. Therefore, the probability of a given slot being the winning slot for any given roulette wheel spin is scientifically measurable, and this measurement is universally agreed upon as acceptable.

As used herein, a real world event shall be construed to mean: (1) an event that occurs offline; (2) an event in which the outcome is not within the control of the promotion program provider; and (3) an event having possible outcomes where the probability of a given possible outcome occurring is not scientifically measurable by any universally agreed upon standards. Moreover, the probability of each possible outcome occurring will generally not be equal to the probability of any one of the other possible outcomes.

An example is the National Championship in the upcoming college football season. It will be understood that this event occurs offline and its outcome is not within the control of the promotion program provider. While the college football team most likely be crowned National Champion for any given year is the Florida State University Seminoles, the probability of this occurring for the upcoming season cannot be scientifically measured, and particularly not by any universally agreed upon standards.

Another example of a real world event, as used herein, is the U.S. Presidential Election. The election occurs offline and is not within the control of the promotion program provider. Although polls can be conducted to determine popularity, the probability of any candidate winning cannot be scientifically measured, and particularly not by an universally agreed upon standards. The most recent presidential election between President George W. Bush, Jr. and former Vice President Al Gore perhaps illustrates this point best.

Still another example is the closing price of common stock issued by a particular company. The movement of price is determined by offline activities. The promotion program provider does not control stock price movement, even when the stock in question is that of the program provider. And, the probability of the stock price being set at a certain level cannot be scientifically measured, particularly by any universally agreed upon standards.

Predicting the outcome of upcoming real world events, as those words are used herein, has always been intriguing to people. For a number of reasons, people enjoy trying to predict the outcome of future events correctly. When they predict correctly, it makes them feel as if they are smart, or exhibit clairvoyance. The enjoyment level of trying to predict the outcome of future events typically increases when those making predictions have an incentive based upon correct prediction of the outcome. The promotion program described herein allows program participants to predict the outcome of upcoming real world events, and to have an incentive based upon the correctness of their prediction that enables them to have the opportunity to be rewarded with prizes, incentives and coupons when their respective predictions turn out to be correct. Because program participants are free to select any possible outcome as their predicted outcome, they will have a sense that they control their own destiny for success in the program.

In light of the foregoing, it is desirable to develop an online promotion program.

It is further desirable to develop an online promotion program that can be utilized by clients doing business online and/or offline.

It is further desirable to develop an interactive promotion program.

It is further desirable to develop a promotion program that gives offline and online clients the ability to acquire, excite, retain and engage a target audience using a complete set of tools that yields quantifiable results.

It is further desirable to develop a promotion program that, in an effective manner, fills the gap between the concept of attracting program participants and the concept of retaining them.

It is further desirable to develop a custom, co-branded promotion program architecture.

It is further desirable to develop a promotion program that features a plurality of fully integrated promotion tools.

It is further desirable to develop a promotion program that provides for game hosting, rules administration, detailed marketing reports and prize and incentive fulfillment.

It is further desirable to develop a promotion program that optimizes a client's investment in marketing by boosting marketing dollar return on investment.

It is further desirable to develop a promotion program that can be adapted to require user registration to commence participation in the promotion program.

It is further desirable to develop a promotion program that increases the frequency and duration of user participation.

It is further desirable to develop a promotion program that increases the average length of visit to a website by the internet user program participants.

It is further desirable to develop a promotion program that increases company visibility.

It is further desirable to develop a promotion program that builds brand awareness.

It is further desirable to develop a promotion program that permits lowering of software maintenance through outsourcing.

It is further desirable to develop a promotion program that enables clients to lower their costs on product promotion efforts.

It is further desirable to develop a promotion program that reduces customer acquisition costs for program clients.

It is further desirable to develop a promotion program that drives online revenue.

It is further desirable to develop a promotion program that drives sales.

It is further desirable to develop a promotion program that increases the clients' knowledge of their respective target audiences.

It is further desirable to develop a promotion program that permits acquisition of demographic and contact information for program participants.

It is further desirable to develop a promotion program that supports a co-branded points-based reward system.

It is further desirable to develop a promotion program that can use a co-branded form of currency as a liquid element of online program participation.

It is further desirable to develop a promotion program having an architecture flexible enough to integrate with sites having loyalty programs or alternative point-based programs in place.

It is further desirable to develop a promotion program that offers websites a consistently updated gaming architecture based on prediction of upcoming real world events to build loyalty and offer clever, cost-efficient methods to acquire and retain program participants, and thereby acquire and retain loyal consumers of the brands offered for sale by the promotion program client.

It is further desirable to develop a promotion program offering business-to-business services.

It is further desirable to develop a promotion program that rewards program participants for client-defined actions.

It is further desirable to develop a promotion program that is dynamic in that it can be continuously updated, which in turn, can enhance its appeal to promotion program participants.

It is further desirable to develop a promotion program that increases web and internet trafficking.

It is further desirable to develop a promotion program that induces repeat and long visits by website visitors.

It is further desirable to develop a promotion program that provides accurate return on investment reporting for program clients.

It is further desirable to develop a promotion program that minimizes maintenance of promotional tools for clients.

It is further desirable to develop a promotion program that minimizes overhead of utilizing promotional tools.

These and other desired benefits of the preferred form of the invention will become apparent from the following description. It will be understood, however, that a system or method could still appropriate the claimed invention without accomplishing each and every one of these desired benefits, including those gleaned from the following description. The appended claims, not these desired benefits, define the subject matter of the invention. Any and all benefits are derived from the preferred form of the invention, not necessarily the invention in general.

### BRIEF SUMMARY OF THE INVENTION

In a particular aspect, the present invention is directed to an online, fully integrated promotion program that preferably includes a promotion program tool in which a program participant acquires a quantity of promotion program points, reviews an upcoming real world event, reviews a select set of possible outcomes for the event, and selects one of the possible outcomes as a prediction entry. The participant also associates the quantity of points with the selected prediction entry. The selected prediction entry can be classified as a winning prediction entry if the outcome of the real world event corresponds thereto. If the prediction entry is a winning prediction entry, the promotion program administrator distributes a reward to the program participant for making a winning prediction entry during participation in said promotion program.

Additional promotion program tools can be included within the promotion program, all of which are described herein.

### BRIEF DESCRIPTION OF THE SEVERAL VIEWS OF THE DRAWING

In describing the preferred aspects of the present invention, reference is made to the accompanying views of the drawing wherein like subject matter has like reference numerals, and wherein:

FIG. 1A is a flowchart diagram illustrating administration of one promotion program tool for an online promotion program developed in accordance with the principles of the present invention;

FIG. 1B is a flowchart diagram illustrating in further detail preferred aspects of a portion of the flowchart diagram depicted in FIG. 1A;

FIG. 1C is a flowchart diagram illustrating participation in the promotion program tool administered in accordance with the flowchart diagram depicted in FIG. 1A;

FIG. 1D is a flowchart diagram illustrating in further detail alternative preferred aspects of a portion of the flowchart diagram depicted in FIG. 1A;

FIG. 2A is a flowchart diagram illustrating administration of another promotion program tool for an online promotion program developed in accordance with the principles of the present invention;

FIG. 2B is a flowchart diagram illustrating participation in the promotion program tool administered in accordance with the flowchart diagram depicted in FIG. 2A;

FIG. 3A is a flowchart diagram illustrating administration of another promotion program tool for an online promotion program developed in accordance with the principles of the present invention;

FIG. 3B is a flowchart diagram illustrating participation in the promotion program tool administered in accordance with the flowchart diagram depicted in FIG. 3A;

FIG. 4A is a flowchart diagram illustrating administration of another promotion program tool for an online promotion program developed in accordance with the principles of the present invention;

FIG. 4B is a flowchart diagram illustrating participation in the promotion program tool administered in accordance with the flowchart diagram depicted in FIG. 4A;

FIG. 5A is a flowchart diagram illustrating administration of another promotion program tool for an online promotion program developed in accordance with the principles of the present invention; and

FIG. 5B is a flowchart diagram illustrating participation in the promotion program tool administered in accordance with the flowchart diagram depicted in FIG. 5A.

### DETAILED DESCRIPTION OF THE INVENTION

Throughout this description, different promotion program tools are illustrated and described as forming individual parts of a comprehensive, fully integrated promotion program. While implementation of the entire promotion program is most preferred, it will be appreciated that one or more of the promotion program tools illustrated and described herein can be sufficient for the promotional and marketing needs of a particular promotion program client. Accordingly, the promotion program tools illustrated and described herein can be used by a promotion program client as the entire promotion program (including all tools), as combinations less than the entire promotion program, or even individually. The client's needs will dictate the extent of the promotion program. It is the intention that unless otherwise explicitly limited thereto, the claims forming the conclusion of this description shall not be construed to require that each and every promotion program tool illustrated and described herein be a part thereof.

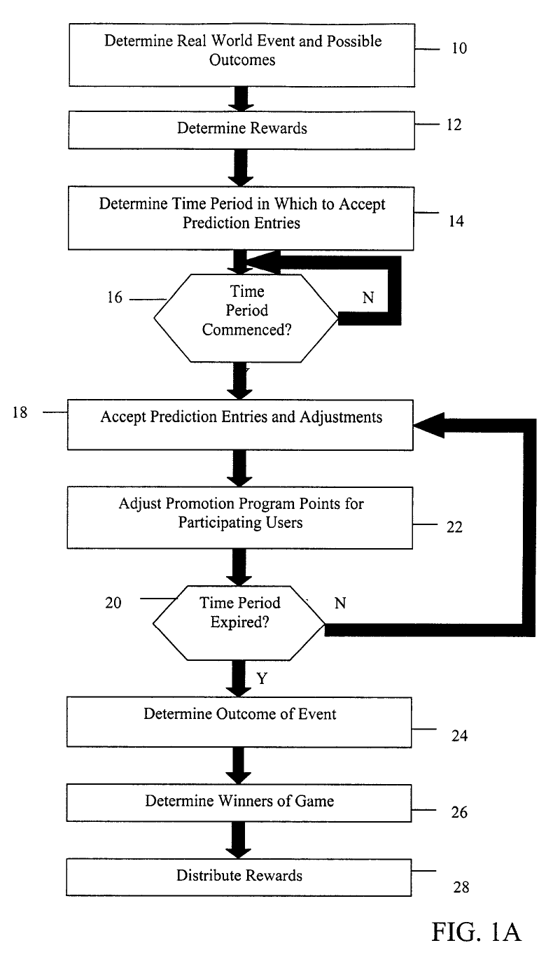

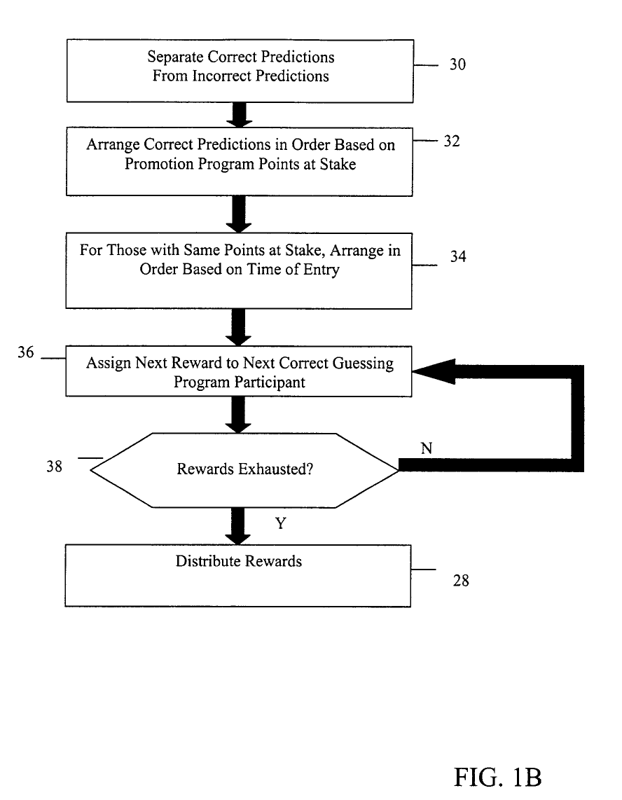

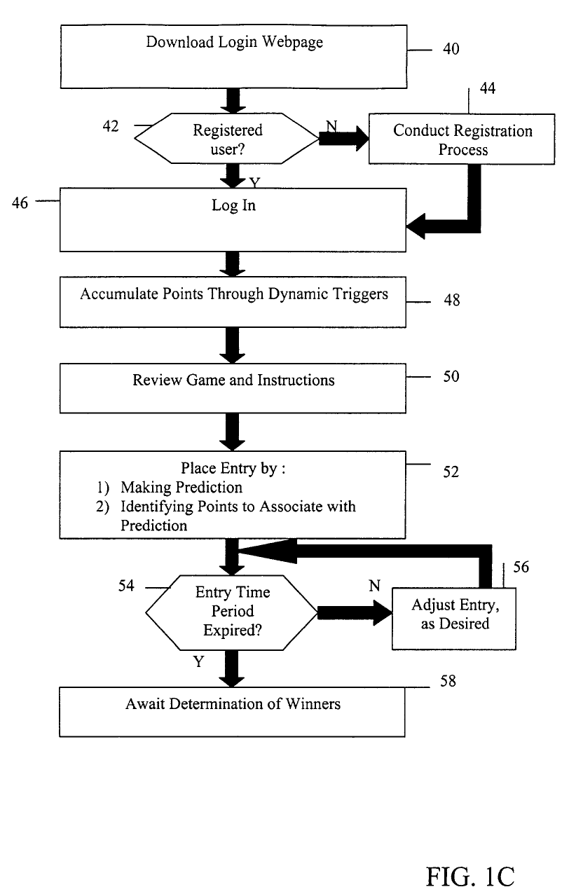

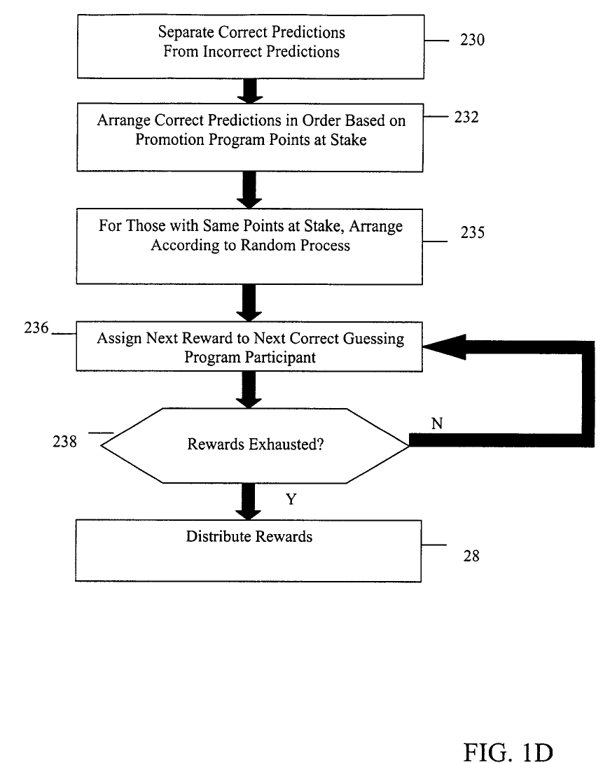

FIG. 1A illustrates a flowchart diagram representing preferred aspects for administration of a first promotion program tool included as part of an online promotion program. In this promotion program tool, program participants predict the outcome of upcoming real world events and they can be rewarded with prizes, incentives and coupons based upon the accuracy of their respective predictions, among other things.

To administer the promotion program tool, and as illustrated by block 10, the upcoming real world event is determined, along with all possible outcomes for that event. As used herein, each outcome has no universally agreed upon scientifically measurable probability of occurring. It will be appreciated that the upcoming real world event is determined based upon its projected appeal to program participants. For instance, on a sports related website, the upcoming real world event will preferably be a future sporting event, such as the World Series. Similarly, on a financial news website, the upcoming real world event will preferably relate to financial news, such as the closing price for shares of common stock issued by a particular company. This determination will preferably be made jointly by the promotion program provider and promotion program client, and it preferably will be tailored to the business interests of the client.

As illustrated by block 12, the prizes and incentives for winning participants are also determined. Examples of prizes could include automobiles, vacation trips and consumer electronics. Incentives could include coupons, gift certificates and similar offerings. Promotion program points could also be awarded.

Block 14 illustrates that the prediction entry time period is also determined. As will be appreciated, the entry time period could be for any length of time, but should end prior to the real world event, and preferably sufficiently prior to the event to allow for the carrying out of final pre-event administrative matters as the event approaches.

The entry time period will preferably comprise a window of time in which the program participants can place prediction entries by attempting to predict the outcome of the upcoming real world event. Preferably, the participants will be entitled to amend or cancel their entries up until the expiration of the entry time period. Program participants will preferably be adequately notified of the entry time period to permit them to participate in this promotion tool of the promotion program.

Block 16 identifies that prediction entries will not be accepted until the entry time period has commenced. After commencement, prediction entries are accepted, as illustrated by block 18, until the entry time period expires, as illustrated by block 20. It will be appreciated that each program participant preferably will be entitled only to one prediction entry. As stated above, program participants preferably will be entitled to amend or cancel their entries up until the expiration of the entry time period (see block 18).

With each prediction entry, program participants will identify an amount of promotion program points to associate therewith, as described in further detail below. At the time each prediction entry is made, the program administrator will store the entry and the program points associated with that prediction entry.

Furthermore, the program administrator will preferably generate and store timing data indicative of the time at which the prediction entry was made, for reasons which shall become apparent through reading this description. This timing data can be in the form of a time stamp or the like.

Moreover, for each promotion program participant, the program administrator will preferably adjust the promotion program point total in her account by deducting the promotion points she selected to associate with her prediction from her prior point total, as illustrated by block 22. It will be appreciated that the program administrator will initiate, update and store promotion program account data for each program participant. These accounts will preferably be set up at the time of registration to the client's website, and updated automatically and continuously during program participation, as desired. It will be appreciated that this adjustment of the promotion program points for participating users can alternatively be conducted after expiration of the prediction entry time period.

Upon expiration of the entry time period, the program administrator will determine the outcome of the real world event upon its occurrence, block 24, determine the winning participants, if any, block 26, and distribute the predetermined prizes and/or incentives to them, block 28.

FIG. 1B illustrates a flowchart diagram representing a preferred method for determining the winners of games administered in accordance with the flowchart diagram depicted in FIG. 1A. This preferred method is carried out at block 26 of FIG. 1A.

In the preferred method illustrated in FIG. 1B, first, in a winning participants database established and stored by the program administrator, data indicative of the participants who placed prediction entries that turned out to be correct will be separated from data indicative of the participants who placed prediction entries that turned out to be incorrect, as illustrated by block 30. This can be carried out in any manner known in the art, such as by deleting data indicative of the incorrect guessing participants from the database.

Next, as illustrated by block 32, the data indicative of the correct guessing participants will preferably be arranged in ascending or descending order based upon the promotion points associated with each prediction entry made by each correct guessing participant. This also can be carried out in any manner known in the art, such as through the use of a simple computer algorithm designed to make this arrangement of the database records.

Thereafter, as illustrated by block 34, for each set of the correct guessing participants who selected the same number of promotion program points to be associated with their respective prediction entries, the data indicative of the time of prediction entry will be utilized to determine a corresponding order of those participants within that set. Preferably, earlier correct prediction entries having the same amount of points associated therewith will earn a higher ranking among the group of correct guessing participants, and therefore a better opportunity to be a winning participant, to win a more desirable prize or incentive, or both.

In this regard, if, at block 32, the correct guessing participants were arranged in ascending order according to promotion program points associated with their respective prediction entries, then within a set of correct guessing participants who selected the same number of promotion program points to associate with their respective prediction entries, the participants within that set will be arranged beginning with the participant therein having the most recent prediction entry and continuing in order to the participant therein having the earliest prediction entry. If, on the other hand, at block 32, the correct guessing participants were arranged in descending order according to their selected promotion points associated with their respective prediction entries, then within a set of correct guessing participants who selected the same number of promotion points to associate with their respective prediction entries, the participants within that set will be arranged beginning with the participant therein having the earliest prediction entry and continuing in order to the participant therein having the most recent prediction entry.

After the correct guessing participants have been arranged as detailed above, the prizes and incentives to be awarded for that game will be awarded in order to the participants, as illustrated by block 36. Block 38 represents that this process continues until all prizes and incentives to be awarded for that game are exhausted. The prizes are then distributed to the award winning participants, as illustrated by block 28, which is also shown in FIG. 1A. Distribution of the applicable prizes can be instant, as in the case of online coupon distribution, or can take several days or more, as in the case of distribution of tangible goods by delivery.

It will be appreciated from the foregoing that the winning participants for each game are determined according to the accuracy of each prediction entry, the quantity of promotion program points associated with each accurate prediction entry, and for those prediction entries having the same number of points associated therewith, the time at which each entry was made. In addition to the method of determining winning participants illustrated in FIG. 1B and described above, other methods of determining the same could be utilized to base determination of the winning participants on these factors.

FIG. 1C illustrates a flowchart diagram representing a preferred method for play of games administered in accordance with the flowchart diagram depicted in FIG. 1A. Promotion program participants will download the game-enabling webpages designed to permit play of the game, as illustrated by block 40, which will preferably be downloaded from servers controlled by the program provider. Preferably, each game will be comprised of multiple web pages in the form of HTML or similar files stored on the servers of the program provider. Access to those web pages will preferably be permitted through the client's website, such as via an HTML hyperlink positioned on a webpage associated with the client's website. The first such webpage is preferably a login webpage, as described in illustrated block 40.

Block 42 illustrates that a decision is made regarding whether each program participant is a registered user of the promotion program. Preferably, in order to register for the promotion program, the program participant must also be a registered user of any website controlled by the promotion program client. If the participant is not a registered user of the promotion program, a registration process is conducted by downloading a registration webpage, as shown by block 44, in which demographic and contact information for the promotion program participant can be acquired. Username and password information, preferably created by the participant, are also preferably acquired. Furthermore, as an option, the participant could be asked to fill out a survey designed to accumulate valuable marketing information for the promotion program client.

As will be appreciated, this registration process is preferably conducted on a registration webpage derived from HTML or similar files stored on a server controlled by the promotion program client. However, this registration process can also be conducted on a registration webpage derived from HTML or similar files stored on a server controlled by the promotion program provider, particularly in the case where the promotion program client does not operate a website.

If the participant is a registered user of the promotion program, the participant then completes a login process, as illustrated by block 46, preferably by inputting her selected username and optional password in appropriate fields on the login webpage.

After logging in to participate in the game, the participant is able to accumulate promotion program points for play in the promotion program by actuating dynamic triggers selectively present on any webpage associated with the game. This is illustrated by block 48 in FIG. 1C. Preferably, dynamic triggers are present on webpages associated with the program client's website, if any, in order to increase traffic to that site. Also, a preselected number of promotion program points preferably are granted upon inception and initial sign up to play the game. It will be appreciated that preferably the promotion program points are a co-branded form of currency in that they can be commonly referred to under brand names associated both with the promotion program provider and the promotion program client.

The dynamic triggers are preferably single lines of HTML or similar code that permit the participant to accumulate promotion program points by performing tasks defined by the program client. For example, the client might desire the participant to complete surveys asking valuable marketing questions for future products and the like. Another example of a client-defined action could include requiring the program participant to actuate an HTML link and thereby download the webpage associated with an advertiser's HTTP protocol address. It will be appreciated that this would be particularly desirable for websites having business models that generate revenue through banner advertising and the like. Still another example of a client-defined action would be the purchase of goods on electronic commerce sites or the entry of a bid for goods offered in an electronic commerce auction. The options are unlimited.

Most importantly, the client defines the participant actions that will trigger the accumulation of promotion program points in participant accounts. Preferably, the client will also determine the number of promotion program points to reward for performance of each defined action. Those actions having more intrinsic value, or requiring more time to complete, will typically provide for a larger number of points than others.

At some point, the participant will decide to participate in the game and will review the offered game, its rules, and instructions for play, as illustrated by block 50. Sometime during the entry time period, each participant will place a prediction entry identifying her prediction of the outcome of the upcoming real world event and identifying the amount of points from her account she desires to associate with her prediction. A minimum and/or maximum point valve may be set by the program administrator, as desired. This is illustrated by block 52. At that same time, the prediction entry is preferably tagged with a time stamp or the like, identifying the time the entry was made. As explained above, this helps to determine the game winners, particularly in the event of what would otherwise result in a tie.

Blocks 54 and 56 represent that the program participants preferably are able to cancel or amend their prediction entries up to the expiration of the prediction entry time period. In addition to canceling her entry altogether, each participant can change her prediction, change the promotion program points associated with her prediction, or both. The promotion program points associated with her prediction can be increased or decreased, as desired. Each adjustment of the prediction entry is treated as a new prediction entry altogether so that with each adjustment, a new time stamp or the like is tagged to the prediction entry and the prior time stamp can be deleted, or maintained for historical purposes. Each participant is preferably entitled to only one prediction entry.

Upon expiration of the entry time period, each participant will await identification of the winning participants, as illustrated by block 58. Notification can occur through a variety of means including posting on a webpage, email notification, instant distribution of any applicable prize, etc.

Variations to the above-described promotion program tool are available. For instance, in the event where a promotion program client does not have a website, the game module can be hosted on a webpage operated and hosted by the promotion program provider or an affiliate thereof. Under these circumstances, the promotion program provider will preferably host the registration process for the client, and will provide the client with relevant demographic and contact information acquired from program participants. In addition to the foregoing, additional surveys can be implemented with the above-described tool that rewards program participants upon completion.

FIG. 1D illustrates a flowchart diagram representing another preferred method for determining the winners of games administered in accordance with the flowchart diagram depicted in FIG. 1A. This preferred method can alternatively be carried out at block 26 of FIG. 1A.

In the preferred method illustrated in FIG. 1D, first, in a winning participants database established and stored by the program administrator, data indicative of the participants who placed prediction entries that turned out to be correct will be separated from data indicative of the participants who placed prediction entries that turned out to be incorrect, as illustrated by block 230. This can be carried out in any manner known in the art, such as by deleting data indicative of the incorrect guessing participants from the database.

Next, as illustrated by block 232, the data indicative of the correct guessing participants will preferably be arranged in ascending or descending order based upon the promotion points associated with each prediction entry made by each correct guessing participant. This also can be carried out in any manner known in the art, such as through the use of a simple computer algorithm designed to make this arrangement of the database records.

Thereafter, as illustrated by block 235, for each set of the correct guessing participants who selected the same number of promotion program points to be associated with their respective prediction entries, each correct guessing participant within that set will be arranged according to a random process. The random process could be any such process available, such as a random computer process, a random drawing or the like. Through the random process, a corresponding order of those participants within that set is determined.

After the correct guessing participants have been arranged as detailed above, the prizes and incentives to be awarded for that game will be awarded in order to the participants, as illustrated by block 236. Block 238 represents that this process continues until all prizes and incentives to be awarded for that game are exhausted. The prizes are then distributed to the award winning participants, as illustrated by block 28, which is also shown in FIG. 1A. Distribution of the applicable prizes can be instant, as in the case of online coupon distribution, or can take several days or more, as in the case of distribution of tangible goods by delivery.

It will be appreciated from the foregoing that the winning participants for each game are determined according to the accuracy of each prediction entry, the quantity of promotion program points associated with each accurate prediction entry, and for those prediction entries having the same number of points associated therewith, a random process. In addition to the method of determining winning participants illustrated in FIG. 1D and described above, other methods of determining the same could be utilized to base determination of the winning participants on these factors.

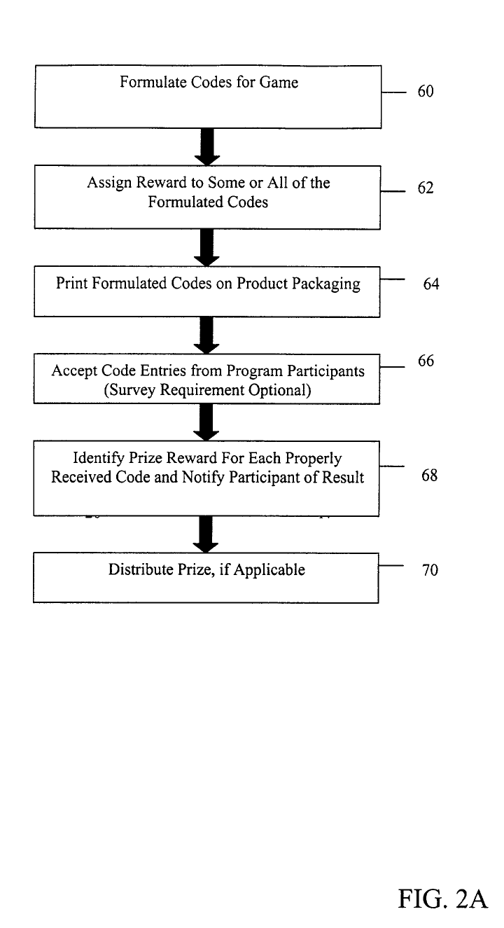

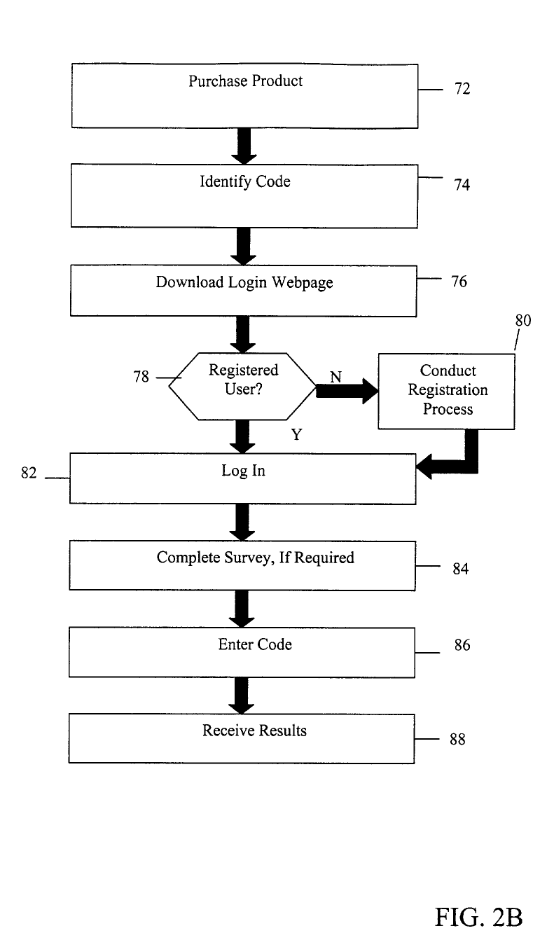

FIG. 2A illustrates a flowchart diagram representing preferred aspects for administration of a second promotion program tool included as part of an online promotion program. In this promotion program tool, program participants receive codes, which are preferably associated with purchased products. Preferably included with the codes is an HTTP protocol web address. The program participants download the webpage associated with the HTTP protocol web address, and enter the code in a field present on the webpage. Upon completion of the foregoing, the participant is notified whether she has won a prize or incentive offered through the program. Preferably, this notification is instant. A survey requirement is optional.

To administer the promotion program tool, and as illustrated by block 60, the program administrator formulates codes for the promotion tool. The codes can be numeric only, alphabetic only, or alphanumeric.

Prize and incentive awards are assigned to select ones of the formulated codes, as shown by block 62. Preferably, some of the formulated codes have no award assigned thereto. The preferred awards include prizes and coupons. Within certain promotion programs available under the principles of the present invention, promotion program points can be an award and can even be used during play of other tools of the online promotion program.

At block 64, the codes and the HTTP protocol web address enabling play of the promotion tool are preferably printed on the product packaging of goods to be sold. As will be appreciated, the goods will preferably be sold by the promotion program client under at least one of its brand names. Thus, this promotion will not only drive sales for such goods, assuming they are ordinarily sold by the promotion program client, but will also enhance brand loyalty.

It will further be appreciated that while printing on product packaging is preferred, any means for delivering the codes and the HTTP protocol web address to the program participant will suffice. For instance, the codes and HTTP protocol web address can be sent to participants via electronic mail, and can even be identified on a banner pulled by a low flying airplane. In any event, it is preferred that something associated with the sale of a good bears code indicia representing the code assigned to that particular good, and further that it or something else associated with the sale of that particular good bears HTTP protocol web address indicia representing the HTTP protocol web address associated with a webpage enabling play of the promotion program tool.

At block 66, code entries are accepted from program participants after they have entered the code at a webpage assigned or linked to the HTTP protocol address. Preferably, the participants are required to complete a survey. As is the case with every tool of this described promotion program, each program participant can be required to be registered to participate in the promotion program, which can including requiring the participant to be a registered user of the website for the program client. It will be appreciated that the optional survey completed at this stage will permit the promotion program client to obtain valuable information regarding the demographics, thoughts and impressions of consumers of its products.

After acceptance of each properly received code, the prize and/or incentive, if any, associated with that code is identified and the program participant is notified of the result. This is illustrated by block 68. Notification can occur by a variety of means, but it will be appreciated that instant notification is most preferred, which can be carried out by transmission over the internet in any manner known in the art.

As illustrated by block 70, the program administrator distributes prizes and incentives, either immediately as they are awarded or periodically such as upon completion of a time period in which codes are accepted from internet users. Incentives and prizes, to the extent possible, can be distributed online. In the case where promotion program points constitute the awarded prize, the total number of points in the promotion points account of the winning participant is increased by the applicable number of awarded points. In this case, distribution of the prize is preferably immediate.

FIG. 2B illustrates a flowchart diagram representing a preferred method for play of the promotion program tool administered in accordance with the flowchart diagram depicted in FIG. 2A. Promotion program participants will first purchase a product, as illustrated by block 72. Preferably, the product will have sufficient promotional materials at the point of sale that will inform the participant that it is sold in accordance with the promotion program.

The product purchaser identifies the code and HTTP protocol address indicated with the product, block 74, and then downloads the game-enabling webpages designed to permit play of the game, as illustrated by block 76, which will preferably be downloaded from servers controlled by the program provider. Preferably, each game will be comprised of multiple web pages in the form of HTML or similar files stored on the servers of the program provider. Access to those web pages will preferably be permitted through the client's website, such as via an HTML hyperlink positioned on a webpage associated with the client's website. The first such webpage is preferably a login webpage, as described in illustrated block 76.

Block 78 illustrates that a decision is made regarding whether the program participant is a registered user of the promotion program. Preferably, in order to register for the promotion program, the program participant must also be a registered user of any website controlled by the promotion program client. If the participant is not a registered user of the promotion program, a registration process is conducted by downloading a registration webpage, as shown by block 80, in which demographic and contact information for the promotion program participant can be acquired. Username and password information, preferably created by the participant, are also preferably acquired. Furthermore, as an option, the participant could be asked to fill out a survey designed to accumulate valuable marketing information for the promotion program client.

As will be appreciated, this registration process is preferably conducted on a registration webpage derived from HTML or similar files stored on a server controlled by the promotion program client. However, this registration process can also be conducted on a registration webpage derived from HTML or similar files stored on a server controlled by the promotion program provider, particularly in the case where the promotion program client does not operate a website.

If the participant is a registered user of the promotion program, the participant then completes a login process, as illustrated by block 82, preferably by inputting her selected username and optional password in appropriate fields on the login webpage.

At block 84, the participant must complete a survey, if required, which can ask for additional demographic and contact information, along with further marketing information such as the thoughts and impressions of the consumer. This survey requirement is optional. Even if not required, completion of a survey can be optional. At block 86, the participant enters the code in an appropriate field on the webpage. At block 88, the participant awaits and receives results from entry of the code. The results can be sent to the participant in any manner chosen by the program administrator, but it will be appreciated that instant notification is most preferred. Receipt of the reward could be instant, as in the case of online coupon distribution, or could take several days or more, as in the case of distribution of tangible goods by delivery.

It will be appreciated that the order of the operations illustrated by blocks 84 and 86 is entirely optional. For instance, it could be beneficial to have the participant complete the survey, if required, after entering the code, for several reasons.

For one thing, this would delay informing the participant that the survey needs to be completed until the last possible action. The participant would feel she is almost done, and it would perhaps more likely increase participation, which in turn would result in a higher survey completion rate.

For another thing, because the code would already be identified, this would allow the survey to be tailored to the product purchased by the participant. As a result, survey questions addressing the participant's impression of the product and its packaging could be asked. This would be particularly desirable in the case where codes are associated with a variety of different products sold by the program client.

Variations to the above-described promotion program tool are available. For instance, in the event where a promotion program client does not have a website, the game module can be hosted on a webpage operated and hosted by the promotion program provider or an affiliate thereof on its server or servers. Under these circumstances, the promotion program provider will preferably host the registration process for the client, and will provide the client with relevant demographic and contact information acquired from program participants. Furthermore, promotion program points could be the applicable award, particularly if other promotion tools are implemented in the promotion program selected by the promotion program client.

For the promotion program tools illustrated and described with reference to FIGS. 1A, 1B, 1C, 1D, 2A and 2B, several additional services will preferably be offered by the promotion program provider. The program provider will preferably offer game consultation services to the client. In particular, the program provider will make recommendations for custom-designed games based upon an assessment of the client's needs and goals.

The program provider will preferably also offer game hosting services for the client. In particular, the hosting of client games and management services can be on servers operated by the promotion program provider.

The program provider will preferably also offer game design and development services for the client. In particular, the provider will create and produce the games played in accordance with the first promotion tool on a per client per game basis.

The program provider will preferably also offer rules administration services for the client. In particular, the provider will draft rules for play to meet client goals within known legal restrictions.

The program provider will preferably also offer reporting services for the client. In particular, the provider will provide detailed reporting on a client's registered user activity in games, which can include game progress and website traffic reports, among other things.

The program provider will preferably also offer consumer inquiry management services for the client. In particular, the provider will provide ongoing management of customer service for program participants.

The program provider will preferably also offer prize fulfillment services for the client. In particular, the provider will judge and determine the winning participants for each game. The provider will also coordinate affidavit and eligibility requirement issues. Further, the provider will coordinate liability release issues. Also, the provider will administer prize determination and distribution.

The program provider will preferably also offer tax issue coordination services for the client. In particular, the provider will coordinate tax issues between the winning participants and clients, if necessary. The provider will send documents to the winning participants for tax purposes.

The program provider will preferably also offer user base hosting services for the client. In particular, the provider will provide for client-defined registration and login processes.

The program provider will preferably also offer demographic data and capture services for the client. In particular, the provider will provide detailed reporting on user base's survey results.

The program provider will preferably also offer promotion trademark and copyright search and registration services for the client. In particular, the provider will have preliminary usage searches conducted, and provide promotional trademark and copyright filing and registration.

The program provider will preferably also offer electronic mail management services for the client. In particular, the provider will communicate with game participants via electronic mail, and can conduct direct marketing efforts on behalf of the client using electronic mail transmission as the medium of communication with program participants.

The program provider will preferably also offer web traffic generation services for the client. In particular, the provider will create online and offline client promotions for the client, including banner advertising, coupon and instant win offerings, etc.

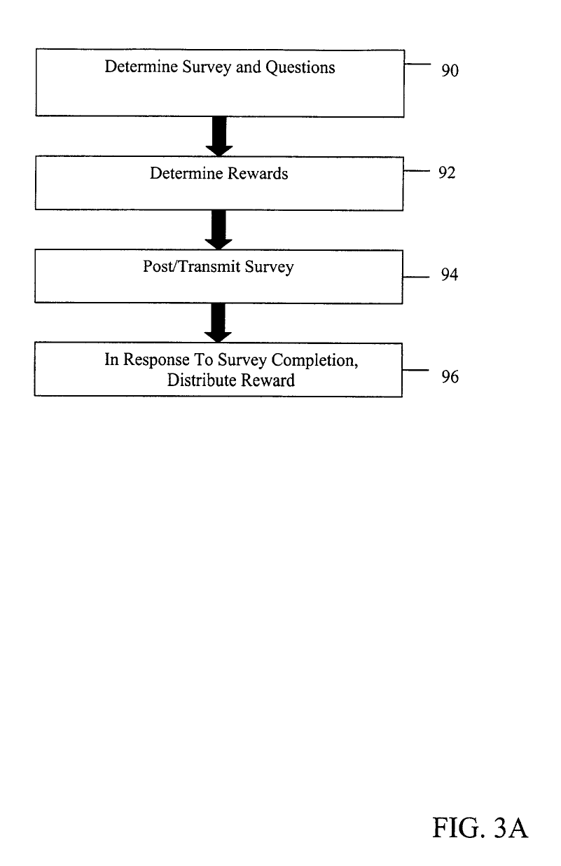

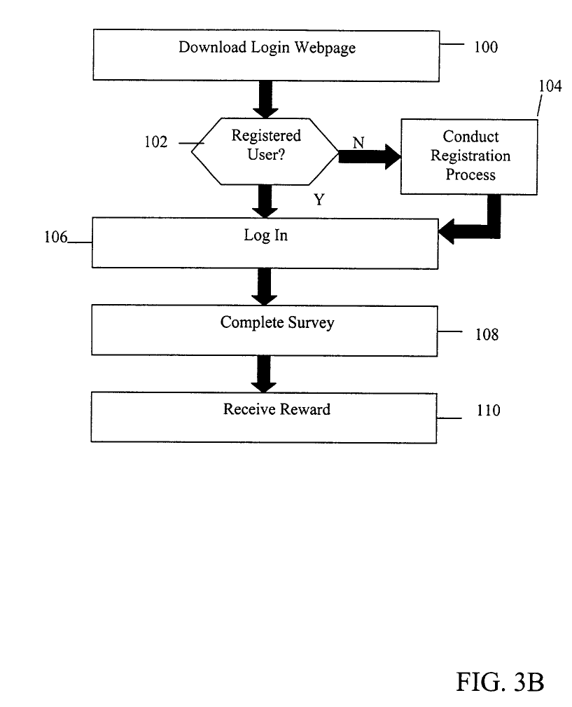

FIG. 3A illustrates a flowchart diagram representing preferred aspects for administration of a third promotion program tool included as part of an online promotion program. In this promotion program tool, program participants complete surveys present online. Preferably, these surveys are located at the client's website. In return for their time in completing the survey, the participants are awarded prizes and/or incentives, which can include promotion program points for play of prediction games, or for application towards other prizes and/or incentives in a loyalty-based promotion program tool. Preferably, each participant can complete each survey only once.

To administer the promotion program tool, the survey questions (block 90) and the prizes and/or incentives (block 92) are determined. Thereafter, the survey is posted on the client's website or otherwise transmitted to the promotion program participants, as illustrated by block 94. HTML code indicative of the prizes and/or incentives to be rewarded are posted in association with the survey to enable program participants to identify the fruits of completing the survey. In response to proper completion of the survey, the administrator distributes the applicable prizes or incentives to the respondent, as illustrated by block 96.

FIG. 3B illustrates a flowchart diagram representing a preferred method for participation in promotions administered in accordance with the flowchart diagram depicted in FIG. 3A. Promotion program participants will first download webpages designed to permit participation in the program, as illustrated by block 100, which will preferably be downloaded from servers controlled by the promotion program provider. Preferably, this tool will be comprised of multiple web pages in the form of HTML or similar files stored on the servers of the promotion program provider. Access to those web pages will preferably be permitted through the client's website, such as via an HTML hyperlink positioned on a webpage associated with the client's website. The first such webpage is preferably a login webpage, as described in illustrated block 100.

Block 102 illustrates that a decision is made regarding whether the program participant is a registered user of the promotion program. Preferably, in order to register for the promotion program, the program participant must also be a registered user of any website controlled by the promotion program client. If the participant is not a registered user of the promotion program, a registration process is conducted by downloading a registration webpage, as shown by block 104, in which demographic and contact information for the promotion program participant can be acquired. Username and password information, preferably created by the participant, are also preferably acquired. Furthermore, as an option, the participant could be asked to fill out a survey designed to accumulate valuable marketing information for the promotion program client.

As will be appreciated, this registration process is preferably conducted on a registration webpage derived from HTML or similar files stored on a server controlled by the promotion program client. However, this registration process can also be conducted on a registration webpage derived from HTML or similar files stored on a server controlled by the promotion program provider, particularly in the case where the promotion program client does not operate a website.

If the participant is a registered user of the promotion program, the participant then completes a login process, as illustrated by block 106, preferably by inputting her selected username and optional password in appropriate fields on the login webpage.

At block 108, the participant completes a survey, which can ask for additional demographic and contact information, along with further marketing information such as the thoughts and impressions of the consumer. At block 110, the participant receives a reward in the form of a prize and/or incentive. Receipt of the reward could be instant, as in the case of online coupon distribution, or could take several days or more, as in the case of distribution of tangible goods by delivery. This promotion program tool is attractive to program participants in that it guarantees reward for completion of a survey. Again, preferably, each participant will be entitled to complete each survey only once.

Variations to the above-described promotion program tool are available. For instance, in the event where a promotion program client does not have a website, the game module can be hosted on a webpage operated and hosted by the promotion program provider or an affiliate thereof. Under these circumstances, the promotion program provider will preferably host the registration process for the client, and will provide the client with relevant demographic and contact information acquired from program participants. In addition to the foregoing, promotion program points could be the applicable award, particularly if other promotion tools are implemented in the promotion program selected by the promotion program client.

For the promotion program tools illustrated and described with reference to FIGS. 3A and 3B, several additional services will preferably be offered by the promotion program provider. The program provider will preferably offer survey consultation services to the client. In particular, the program provider will recommend custom-designed survey structures based upon an assessment of the client's needs and goals.

The program provider will preferably also offer survey hosting services for the client. In particular, the hosting of client surveys and management services can be on servers operated by the promotion program provider.

The program provider will preferably also offer rules administration, reporting, consumer inquiry management, prize fulfillment, tax issue coordination, user base handling, promotion trademark and copyright search and registration, electronic mail management and web traffic generation services for the client. Each of these is described above in further detail.

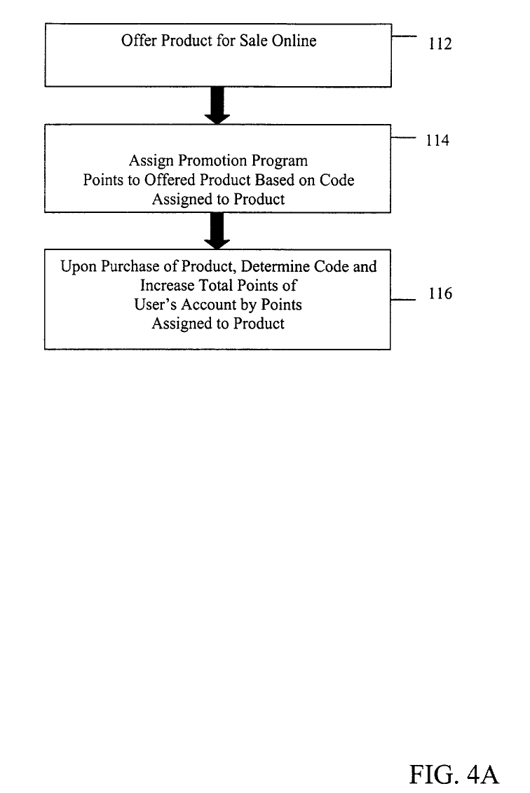

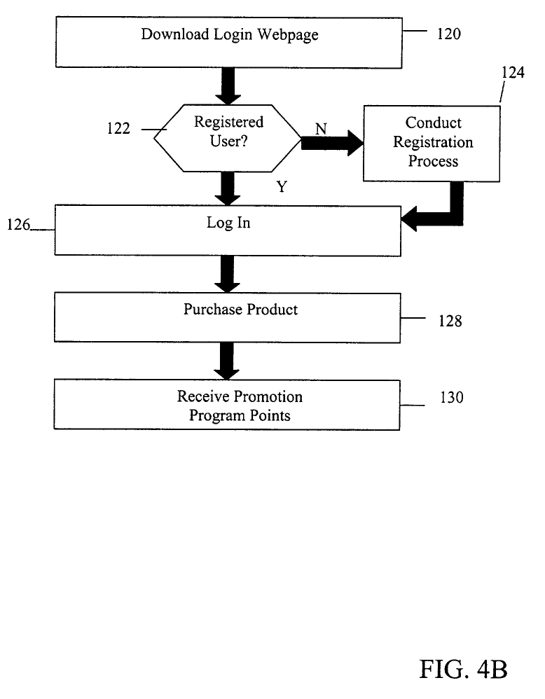

FIG. 4A illustrates a flowchart diagram representing preferred aspects for administration of a fourth promotion program tool included as part of an online promotion program. In this promotion program tool, program participants are awarded promotion program points by purchasing products sold by promotion program clients. These points can be accumulated and redeemed for prizes and/or incentives identified by the promotion program administrator. They can also be used for participation in other ones of the promotion program tools described herein.

To administer the promotion program tool, and as illustrated by block 112, a product is offered for sale online. The program administrator assigns a promotion program point value to the product, block 114, based upon a code assigned to the product. Preferably, the program participants are permitted to view the point value prior to their purchase of the product. Upon purchase of the product by a program participant, the program administrator determines the code assigned to the product and increases the total number of promotion program points forming the balance of the participant's account by the points assigned to the purchased product. This is illustrated by block 116. The participant can be notified of the point increase instantly, or can view her account balance at any time after properly conducting the login process for access to appropriate webpages associated with the promotion program.

FIG. 4B illustrates a flowchart diagram representing a preferred method for participation in promotions administered in accordance with the flowchart diagram depicted in FIG. 4A. Promotion program participants will first download the webpages designed to permit participation in the program, as illustrated by block 120, which will preferably be downloaded from servers controlled by the promotion program provider. Preferably, this tool will be comprised of multiple web pages in the form of HTML or similar files stored on the servers of the program provider. Access to those web pages will preferably be permitted through the client's website, such as via an HTML hyperlink positioned on a webpage associated with the client's website. The first such webpage is preferably a login webpage, as described in illustrated block 120.

Block 122 illustrates that a decision is made regarding whether the program participant is a registered user of the promotion program. Preferably, in order to register for the promotion program, the program participant must also be a registered user of any website controlled by the promotion program client. If the participant is not a registered user of the promotion program, a registration process is conducted by downloading a registration webpage, as shown by block 124, in which demographic and contact information for the promotion program participant can be acquired. Username and password information, preferably created by the participant, are also preferably acquired. Furthermore, as an option, the participant could be asked to fill out a survey designed to accumulate valuable marketing information for the promotion program client.

As will be appreciated, this registration process is preferably conducted on a registration webpage derived from HTML or similar files stored on a server controlled by the promotion program client. However, this registration process can also be conducted on a registration webpage derived from HTML or similar files stored on a server controlled by the promotion program provider, particularly in the case where the promotion program client does not operate a website.

If the participant is a registered user of the promotion program, the participant then completes a login process, as illustrated by block 126, preferably by inputting her selected username and optional password in appropriate fields on the login webpage.

At block 128, the participant purchases a product having a code indicative of a number of promotion program points assigned to it. At block 130, the participant receives the number of promotion program points assigned to the product, as the code is determined and her account balance is increased by that number of points. The points can be accumulated and redeemed for prizes and/or incentives identified by the promotion program administrator. This identification can occur in the form of a rewards bank present on or able to be linked from a webpage associated with participation in the promotion program. As an option, the promotion program points can also be used for participation in other ones of the promotion program tools described herein.

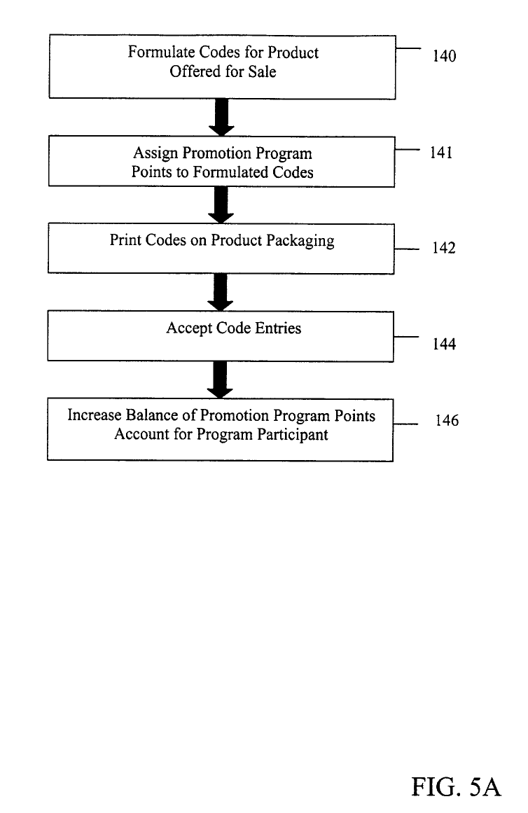

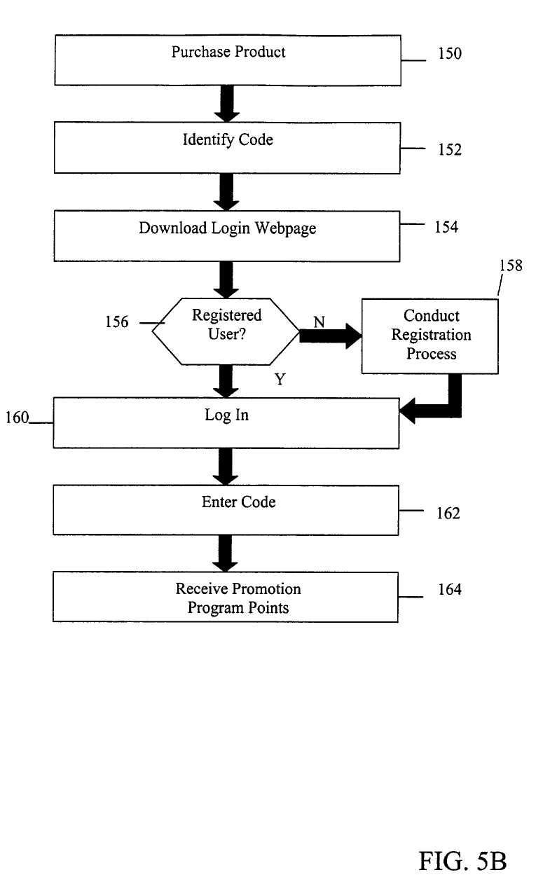

FIG. 5A illustrates a flowchart diagram representing preferred aspects for administration of a fifth promotion program tool included as part of an online promotion program. This promotion program tool is similar to the one administered in accordance with the flowchart diagram depicted in FIG. 4A.

In this promotion program tool, program participants are again awarded promotion program points by preferably purchasing products sold by promotion program clients. These points can be accumulated and redeemed for prizes and/or incentives identified by the promotion program provider. As an option, they can also be used for participation in other ones of the promotion program tools described herein. In this promotion program tool, program participants receive codes, which are preferably assigned to purchased products. These codes are entered in a field present on a webpage associated with participation in the promotion program to increase the promotion program point balance in their respective accounts.

To administer the promotion program tool, and as illustrated by block 140, the program administrator formulates codes for the promotion tool. The codes can be numeric only, alphabetic only, or alphanumeric. A predetermined number of promotion program points is assigned to each code, as illustrated by block 141.

At block 142, the codes and, optionally, the HTTP protocol web address assigned to a webpage associated with participation in the promotion program are preferably printed on the product packaging of goods to be sold.

As will be appreciated, the goods will preferably be sold by the promotion program client under at least one of its brand names. Thus, this promotion tool will not only drive sales for such goods, assuming they are ordinarily sold by the promotion program client, but will also enhance brand loyalty.

It will further be appreciated that while printing on product packaging is preferred, any means for delivering the codes and the HTTP protocol web address to the program participant will suffice (e.g., Email delivery). It is preferred, however, that this delivery occurs at the point of sale. It is also preferred that something associated with the sale of each good bears code indicia representing the code assigned to that particular good, and further that it or something else associated with the sale of that particular good bears HTTP protocol web address indicia representing the HTTP protocol web address assigned to a webpage associated with participation in the promotion program.

At block 144, code entries are accepted from program participants after they have entered the code at a webpage associated with participation in the promotion program. Preferably, this webpage is assigned or linked to the HTTP protocol address received by the program participant upon purchase of the product.

After acceptance of each properly received code, the balance of the account for the promotion program participant is increased by the promotion program points assigned to the entered code, as shown by block 146. Each code will be successfully received once. The program participant can be notified of this increase instantly, or can view her account at any time after proper login to the promotion program.

FIG. 5B illustrates a flowchart diagram representing a preferred method for participation in the promotion program tool administered in accordance with flowchart diagram depicted in FIG. 5A. Promotion program participants will first purchase a product offline, as illustrated by block 150. Preferably, the product will have sufficient promotional materials at the point of sale bearing information identifying that it is sold in accordance with the promotion program. Furthermore, it will preferably have materials bearing information regarding the number of promotion program points assigned to the purchase of the product.

The product purchaser identifies the code and optional HTTP protocol address associated with the product, block 152, and then downloads webpages designed to permit participation and point reward, as illustrated by block 154, which will preferably be downloaded from servers controlled by the program provider. Preferably, this promotion tool will be comprised of multiple web pages in the form of HTML or similar files stored on the servers of the program provider. Access to those web pages will preferably be permitted through the client's website, such as via an HTML hyperlink positioned on a webpage associated with the client's website. The first such webpage is a login webpage, as described in illustrated block 154.

Block 156 illustrates that a decision is made regarding whether the program participant is a registered user of the promotion program. Preferably, in order to register for the promotion program, the program participant must also be a registered use of any website controlled by the promotion program client. If the participant is not a registered user of the promotion program, a registration process is conducted by downloading a registration webpage, as shown by block 158, in which demographic and contact information for the promotion program participant can be acquired. Username and password information, preferably created by the participant, are also preferably acquired. Furthermore, as an option, the participant could be asked to fill out a survey designed to accumulate valuable marketing information for the promotion program client.

As will be appreciated, this registration process is preferably conducted on a registration webpage derived from HTML or similar files stored on a server controlled by the promotion program client. However, this registration process can also be conducted on a registration webpage derived from HTML or similar files stored on a server controlled by the promotion program provider, particularly in the case where the promotion program client does not operate a website.

If the participant is a registered user of the promotion program, the participant then completes a login process, as illustrated by block 160, preferably by inputting her selected username and optional password in appropriate fields on the login webpage.

At block 162, the participant enters the code in an appropriate field on the webpage. At block 164, the participant awaits and receives notification of the promotion point program increase to the balance for her account. This notification can be sent to the participant in any manner chosen by the program administrator, but it will be appreciated that instant notification is most preferred. Also, the participant can preferably review her account balance at any time after proper login.

Variations to the above-described promotion program tool are available. For instance, in the event where a promotion program client does not have a website, the game module can be hosted on a webpage operated and hosted by the promotion program provider or an affiliate thereof. Under these circumstances, the promotion program provider will preferably host the registration process for the client, and will provide the client with relevant demographic and contact information acquired from program participants. Furthermore, promotion program points could be the ultimate award, particularly if other promotion tools are implemented in the promotion program selected by the promotion program client.

For the promotion program tools illustrated and described with reference to FIGS. 4A, 4B, 5A and 5B, several additional services will preferably be offered by the promotion program provider. The program provider will preferably offer loyalty program consultation services to the client. In particular, the program provider will recommend custom-designed loyalty program structures based upon an assessment of the client's needs and goals.

The program provider will preferably also offer loyalty program hosting services for the client. In particular, the hosting of loyalty program and management services can be on servers operated by the promotion program provider.

The program provider will preferably also offer survey hosting, rules administration, reporting, consumer inquiry management, prize fulfillment, tax issue coordination, user base handling, promotion trademark and copyright search and registration, electronic mail management and web traffic generation services for the client. Each of these is described above in further detail.

While this invention has been described with reference to certain illustrative aspects, it will be understood that this description shall not be construed in a limiting sense. Rather, various changes and modifications can be made to the illustrative embodiments without departing from the true spirit and scope of the invention, as defined by the following claims. As one example, the promotion program points granted for participation in any of the foregoing promotion program tools could be identical such that the promotion program tools can share promotion program points. Alternatively, the promotion program points granted for participation in one or more of the foregoing promotion program tools could differ from the promotion program points granted for participation of others of the foregoing promotion program tools such that full sharing is not possible.

Furthermore, it will be appreciated that any such changes and modifications will be recognized by those skilled in the art as an equivalent to one or more elements of the following claims, and shall be covered by such claims to the fullest extent permitted by law.

1. A method for participation in a promotion program, comprising the steps of:
acquiring a quantity of points;
reviewing an upcoming real world event;
reviewing a select set of possible outcomes for said event;
selecting one of said select set of possible outcomes as a prediction entry;
associating said quantity of points with said prediction entry;
awaiting an actual outcome of said upcoming real world event to determine whether said prediction entry might be a winning prediction entry; and
if said prediction entry is a winning prediction entry, receiving a reward for making a winning prediction entry during participation in said promotion program.

2. The method of claim 1 further comprising the steps of downloading a login webpage and conducting a login process to initiate participation in said promotion program.

3. The method of claim 1 further comprising the steps of downloading a registration webpage and conducting a registration process to register for participation in said promotion program.

4. The method of claim 1 wherein said step of selecting one of said select set of possible outcomes as a prediction entry, and said step of associating said quantity of points with said prediction entry are carried out during a prediction entry time period.

5. The method of claim 4 wherein said upcoming real world event occurs after expiration of said prediction entry time period.

6. The method of claim 4 further comprising the step of adjusting said prediction entry during said prediction entry time period and replacing said prediction entry with said adjusted prediction entry.

7. The method of claim 6 further comprising the step of adjusting said quantity of points during said prediction entry time period and associating said adjusted quantity of points with said adjusted prediction entry.

8. The method of claim 4 further comprising the step of adjusting said quantity of points during said prediction entry time period and associating said adjusted quantity of points with said prediction entry.

9. The method of claim 1 wherein said quantity of points is acquired, at least in part, by activating a dynamic trigger included as part of a webpage associated with participation in said promotion program.

10. The method of claim 1 wherein said select set of possible outcomes for said event constitute all possible outcomes for said event.

11. The method of claim 1 further comprising the steps of: purchasing an instant win product having an instant win code associated therewith; identifying said instant win code; entering the instant win code at an instant win webpage associated with participation in said promotion program; and in response to entry of said instant win code, receiving results as to whether entry of said instant win code constitutes an instant win winning entry in said promotion program.

12. The method of claim 11 further comprising the steps of: completing a survey at a survey completion webpage associated with participation in said promotion program; and in response to completion of said survey, receiving a reward.

13. The method of claim 12 further comprising the steps of: purchasing an online product online; and in response to purchase of said online product, receiving a select number of loyalty points that can be applied towards rewards obtainable during participation in said promotion program.

14. The method of claim 13 further comprising the steps of: purchasing an offline product offline having a loyalty code associated therewith; identifying said loyalty code; entering the loyalty code at a loyalty webpage associated with participation in said promotion program; and in response to entry of said loyalty code, receiving a select number of said loyalty points.

15. The method of claim 1 further comprising the steps of: completing a survey at a survey completion webpage associated with participation in said promotion program; and in response to completion of said survey, receiving a reward.

16. The method of claim 15 further comprising the steps of: purchasing an online product online; and in response to purchase of said online product, receiving a select number of loyalty points that can be applied towards rewards obtainable during participation in said promotion program.

17. The method of claim 16 further comprising the steps of: purchasing an offline product offline having a loyalty code associated therewith; identifying said loyalty code; entering the loyalty code at a loyalty webpage associated with participation in said promotion program; and in response to entry of said loyalty code, receiving a select number of said loyalty points.

18. The method of claim 1 further comprising the steps of: purchasing an online product online; and in response to purchase of said online product, receiving a select number of loyalty points that can be applied towards rewards obtainable during participation in said promotion program.

19. The method of claim 18 further comprising the steps of: purchasing an offline product offline having a loyalty code associated therewith; identifying said loyalty code; entering the loyalty code at a loyalty webpage associated with participation in said promotion program; and in response to entry of said loyalty code, receiving a select number of said loyalty points.

20. The method of claim 1 further comprising the steps of: purchasing an offline product offline having a loyalty code associated therewith; identifying said loyalty code; entering the loyalty code at a loyalty webpage associated with participation in said promotion program; and in response to entry of said loyalty code, receiving a select number of loyalty points that can be applied towards rewards obtainable during participation in said promotion program.

21. A method for providing a promotion program, comprising the steps of:
permitting a program participant to acquire a quantity of points;
permitting the program participant to review an upcoming real world event;
permitting the program participant to review a select set of possible outcomes for said event;
permitting the program participant to select one of said select set of possible outcomes as a prediction entry;
permitting the program participant to associate said quantity of points with said prediction entry;
reviewing said upcoming real world event to determine its outcome;
determining whether said prediction entry is a winning prediction entry based, at least in part, on said outcome of said upcoming real world event; and
if said prediction entry is a winning prediction entry, distributing a reward to said program participant for making a winning prediction entry during participation in said promotion program.

22. The method of claim 21 further comprising the step of permitting the program participant to download a login webpage and conduct a login process to initiate participation in said promotion program.

23. The method of claim 21 further comprising the step of permitting the program participant to download a registration webpage and conduct a registration process to register for participation in said promotion program.

24. The method of claim 21 further comprising the step of determining a prediction entry time period and permitting the program participant to select one of said select set of possible outcomes as a prediction entry only during said prediction entry time period, and further permitting the program participant to associate said quantity of points with said prediction entry only during said prediction entry time period.

25. The method of claim 24 wherein said prediction entry time period is determined such that said upcoming real world event is scheduled to occur thereafter.

26. The method of claim 24 further comprising the step of permitting the program participant to adjust said prediction entry during said prediction entry time period and replace send prediction entry with said adjusted prediction entry.

27. The method of claim 26 further comprising the step of permitting the program participant to adjust said quantity of points during said prediction entry time period and to associate said adjusted quantity of points with said adjusted prediction entry.

28. The method of claim 24 further comprising the step of permitting the program participant to adjust said quantity of points during said prediction entry time period and to associate said adjusted quantity of points with said prediction entry.

29. The method of claim 21 further comprising the step of establishing a dynamic trigger forming part of a webpage associated with participation in the promotion program to permit the program participant to acquire said quantity of points, at least in part, by activating said dynamic trigger.

30. The method of claim 21 wherein said select set of possible outcomes for said event constitute all possible outcomes for said event.

31. The method of claim 21 further comprising the steps of: providing an instant win product having an instant win code associated therewith; permitting entry of the instant win code at an instant win webpage associated with participation in said promotion program; and in response to receipt of said instant win code entry, identifying whether said instant win code corresponds to an instant win winning entry in said promotion program.

32. The method of claim 31 further comprising the steps of: formulating a survey to be completed by a survey respondent; including said survey as part of a survey completion webpage associated with participation in said promotion program; and in response to completion of said survey, distributing a reward to the survey respondent.

33. The method of claim 32 further comprising the steps of: providing an online product for sale online; and in response to receipt of an order for purchase of said online product, adding a select number of loyalty points to a participant account such that said loyalty points can be applied towards rewards obtainable during participation in said promotion program.

34. The method of claim 33 further comprising the steps of: providing an offline product for sale offline; associating a loyalty code with said offline product; permitting entry of said loyalty code at a loyalty webpage associated with participation in said promotion program; and in response to receipt of said entered loyalty code, adding a select number of said loyalty points to said participant account.

35. The method of claim 21 further comprising the steps of: formulating a survey to be completed by a survey respondent; including said survey as part of a survey completion webpage associated with participation in said promotion program; and in response to completion of said survey, distributing a reward to the survey respondent.

36. The method of claim 35 further comprising the steps of: providing an online product for sale online; and in response to receipt of an order for purchase of said online product, adding a select number of loyalty points to a participant account such that said loyalty points can be applied towards rewards obtainable during participation in said promotion program.

37. The method of claim 36 further comprising the steps of: providing an offline product for sale offline; associating a loyalty code with said offline product; permitting entry of said loyalty code at a loyalty webpage associated with participation in said promotion program; and in response to receipt of said entered loyalty code, adding a select number of said loyalty points to said participant account.

38. The method of claim 21 further comprising the steps of: providing an online product for sale online; and in response to receipt of an order for purchase of said online product, adding a select number of loyalty points to a participant account such that said loyalty points can be applied towards rewards obtainable during participation in said promotion program.

39. The method of claim 38 further comprising the steps of: providing an offline product for sale offline; associating a loyalty code with said offline product; permitting entry of said loyalty code at a loyalty webpage associated with participation in said promotion program; and in response to receipt of said entered loyalty code, adding a select number of said loyalty points to said participant account.

40. The method of claim 33 further comprising the steps of: providing an offline product for sale offline; associating a loyalty code with said offline product; permitting entry of said loyalty code at a loyalty webpage associated with participation in said promotion program; and in response to receipt of said entered loyalty code, adding a select number of loyalty points to a participant account such that said loyalty points can be applied towards rewards obtainable during participation in said promotion program.

41. A method of determining whether a particular prediction entry having a particular number of points associated therewith placed by a particular program participant constitutes a winning entry in a promotion program wherein a plurality of promotion program participants each place one prediction entry having a participant-selected number of points associated therewith and wherein each said prediction entry is placed at a particular time during which prediction entries are accepted for participation in said promotion program, comprising the steps of:
determining whether said particular prediction entry is correct;
if said particular prediction entry is not correct, then recognizing that said particular prediction entry does not constitute a winning entry in said promotion program;
if said particular prediction entry is correct, then determining which, if any, of other ones of said prediction entries placed by others of said plurality of promotion program participants are correct to separate correct prediction entries from incorrect prediction entries and calculate a total number of correct prediction entries for said promotion program;
if said total number of correct prediction entries for said promotion program is less than or equal to a number of winning entries to be awarded for said promotion program, then recognizing that said particular prediction entry constitutes a winning entry in said promotion program;
if, on the other hand, said total number of correct prediction entries for said promotion program is greater than said number of winning entries to be awarded for said promotion program, comparing the particular number of points associated with said particular prediction entry with the selected number of points associated with said other ones of said correct prediction entries to rank said correct prediction entries in a points-based ranking; and
if the particular number of points associated with said particular prediction entry is identical to the selected number of points associated with at least one of said other ones of said correct prediction entries, then comparing said particular time at which said particular prediction entry was placed by said particular program participant during said promotion program relative to said particular time at which said at least one of said other ones of said correct prediction entries was placed to rank said particular prediction entry relative to said at least one of said other ones of said correct prediction entries.

42. A method of determining whether a particular prediction entry having a particular number of points associated therewith placed by a particular program participant constitutes a winning entry in a promotion program wherein a plurality of promotion program participants each place one prediction entry having a participant-selected number of points associated therewith, comprising the steps of:
determining whether said particular prediction entry is correct;
if said particular prediction entry is not correct, then recognizing that said particular prediction entry does not constitute a winning entry in said promotion program;
if said particular prediction entry is correct, then determining which, if any, of other ones of said prediction entries placed by others of said plurality of promotion program participants are correct to separate correct prediction entries from incorrect prediction entries and calculate a total number of correct prediction entries for said promotion program;
if said total number of correct prediction entries for said promotion program is less than or equal to a number of winning entries to be awarded for said promotion program, then recognizing that said particular prediction entry constitutes a winning entry in said promotion program;
if, on the other hand, said total number of correct prediction entries for said promotion program is greater than said number of winning entries to be awarded for said promotion program, comparing the particular number of points associated with said particular prediction entry with the selected number of points associated with said other ones of said correct prediction entries to rank said correct prediction entries in a points-based ranking; and
if the particular number of points associated with said particular prediction entry is identical to the selected number of points associated with at least one of said other ones of said correct prediction entries, then ranking said particular prediction entry relative to said at least one of said other ones of said correct prediction entries according to a predetermined random process.
